(19) United States
(12) Patent Application Publication
(10) Pub. No.: US 2025/0249896 A1
(43) Pub. Date: Aug. 7, 2025

(54) VEHICLE CONTROL DEVICE

(71) Applicant: TOYOTA JIDOSHA KABUSHIKI KAISHA, Toyota-shi (JP)

(72) Inventor: Keisuke IKARI, Toyota-shi (JP)

(73) Assignee: TOYOTA JIDOSHA KABUSHIKI KAISHA, Toyota-shi (JP)

(21) Appl. No.: 18/987,839

(22) Filed: Dec. 19, 2024

(30) Foreign Application Priority Data
Feb. 1, 2024 (JP) 2024-014319

(51) Int. Cl. B60W 30/09; B60W 30/095; B60W 30/18

(52) U.S. Cl. CPC B60W 30/09; B60W 30/0956; B60W 30/18159; B60W 2554/4046

(57) ABSTRACT

To realize a vehicle control based on collision risk while appropriately determining collision risk at the roundabout and its vicinity, provided is a vehicle control device comprising a processor, wherein the processor is configured to execute a vehicle control for reduce a collision risk between an own vehicle and a target object existing in front of a traveling direction of the own vehicle, when an execution condition is satisfied, the execution condition is satisfied when a determination condition is satisfied, wherein the processor is configured to change the execution condition or the determination condition based on a behavior of the own vehicle on a traveling route and a behavior of other vehicle that is existing on the traveling route, and wherein the traveling route includes a circulation path of a roundabout and vicinity of the roundabout on a connecting path that connect to the circulation path.

### CROSS-REFERENCE TO RELATED APPLICATION

This application claims priority to Japanese Patent Application No. JP 2024-014319 filed on Feb. 1, 2024, the content of which is hereby incorporated by reference in its entirety into this application.

### BACKGROUND OF THE INVENTION

### 1. Field of the Invention

The present disclosure relates to a vehicle control device.

### 2. Description of the Related Art

For example, Japanese Patent Application Laid-Open (kokai) No. 2005-301884 (hereinafter Patent Document 1) discloses a technique in which an infrastructure sensor is installed in a circulation path of a roundabout or a connection path connected to the circulation path, and when a vehicle traveling in the circulation path or a vehicle entering the circulation path is detected by the infrastructure sensor, a detection result is displayed on a bulletin board installed in a central empty place in the circulation path, or is transmitted to a surrounding vehicle through communication.

Even when another vehicle is present in front of own vehicle at the roundabout, notification may not be required depending on the traveling condition of the respective vehicles. For example, when own vehicle exits the circulation path of the roundabout to the connecting path and the other vehicles enter the circulation path from the connecting path, those vehicles are close to each other but do not cross each other. That is, notification is not necessary in such a scene. In the technique described in Patent Document 1, since the notification is not performed in consideration of the traveling state of each vehicle, there is a possibility that the notification is not appropriate in such a scene.

### SUMMARY OF THE INVENTION

The present disclosure has been made in order to solve the above problems, and an object thereof is to realize the vehicle control based on collision risk while appropriately determining collision risk at the roundabout and its vicinity.

A device according to at least one embodiment of the present disclosure is a vehicle control device comprising: a processor, wherein the processor is configured to execute a vehicle control for assist to reduce a collision risk between an own vehicle and a target object existing in a predetermined angle range in front of a traveling direction of the own vehicle, when an execution condition is satisfied, the execution condition is satisfied when a determination condition that the collision risk is greater than or equal to a predetermined level is satisfied, wherein the processor is configured to change at least one of the execution condition or the determination condition based on a behavior of the own vehicle on a traveling route and a behavior of other vehicle that is existing on the traveling route, and wherein the traveling route includes a circulation path of a roundabout and vicinity of the roundabout on a connecting path that connect to the circulation path.

### BRIEF DESCRIPTION OF THE DRAWINGS

FIG. 1 is a schematic diagram of a hardware configuration of a vehicle according to the present embodiment are applied.

FIG. 2 is a schematic diagram showing a software configuration of a control device to the present embodiment.

FIG. 3 is a matrix diagram illustrating a combination of suppressing process by each cases executed by the control device according to the present embodiment.

FIG. 4 is a schematic diagram illustrating each cases of FIG. 3.

FIG. 5 is a flowchart for explaining a routine of a determination process of a traveling state of the other vehicle executed by the control device according to the present embodiment.

FIG. 6 is a flowchart for explaining a routine of suppressing process executed by the control device according to the present embodiment.

### DESCRIPTION OF THE EMBODIMENTS

Description is now given of a vehicle control device according to at least one embodiment of the present disclosure with reference to the drawings.

### <Hardware Configuration>

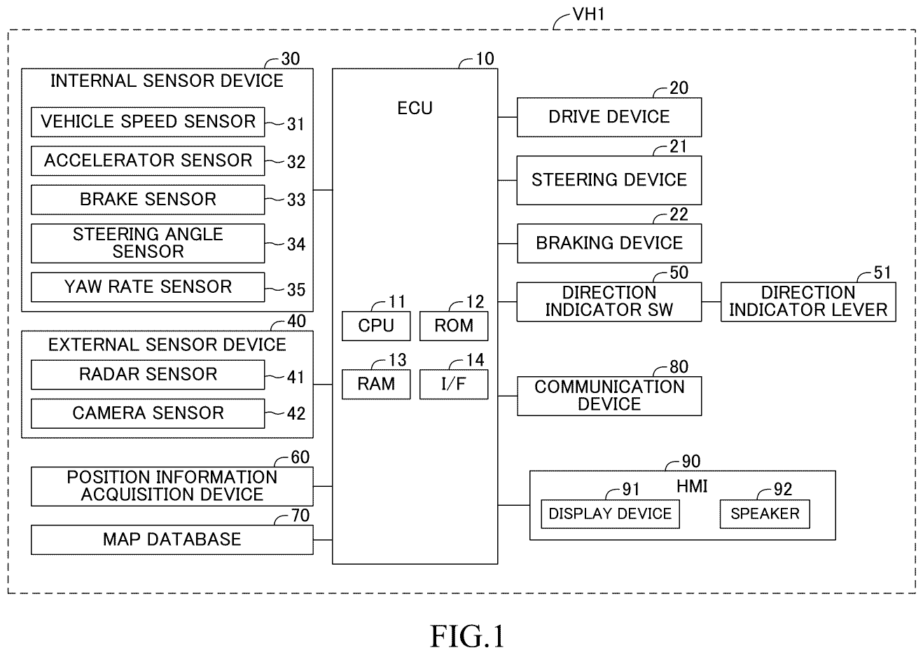

FIG. 1 is a schematic diagram of a hardware configuration of a vehicle VH1 according to the present embodiment. The vehicle VH1 is hereinafter sometimes referred to as “own vehicle” when the vehicle VH1 is required to be distinguished from other vehicles or the like.

The vehicle VH1 has an ECU (Electronic Control Unit) 10. The ECU 10 includes a CPU (Central Processing Unit) 11, ROM (Read Only Memory) 12, RAM (Random Access Memory) 13, an interface device 14, and the like. The CPU 11 executes various programs stored in the ROM 12. The ROM 12 is a non-volatile memory that stores data and the like required for the CPU 11 to execute various programs. The RAM 13 is a volatile memory to provide a working region that is deployed when various programs are executed by the CPU 11. The interface device 14 is a communication device for communicating with an external device.

The ECU 10 is a central device which executes a driving support control such as a collision avoidance control (Pre-Crash Safety Control: hereinafter, a PCS control). The driving support control is a concept including autonomous driving. A drive device 20, a steering device 21, a braking device 22, an internal sensor device 30, an external sensor device 40, a direction indicator switch 50, a position information acquisition device 60, a map database 70, a communication device 80, a HMI (Human Machine Interface) 90, and the like are connected for communication.

The drive device 20 generates a driving force to be transmitted to driving wheels of the vehicle VH1. As the drive device 20, for example, an electric motor and an engine are given. In a driving support device of the at least one embodiment, the vehicle VH1 may be any one of a hybrid electric vehicle (HEV), a plug-in hybrid electric vehicle (PHEV), a fuel cell electric vehicle (FCEV), a battery electric vehicle (BEV), and an engine vehicle. The steering device 21 applies a turning force to the wheels of the vehicle VH1. The braking device 22 applies a braking force to the wheels of the vehicle VH1.

The internal sensor device 30 is sensors which detect states of the vehicle VH1. The internal sensor device 30 specifically includes a vehicle speed sensor 31, an accelerator sensor 32, a brake sensor 33, a steering angle sensor 34, a yaw rate sensor 35, and the like.

The vehicle speed sensor 31 detects a travel speed of the vehicle VH1 (hereinafter referred to as “vehicle speed”). The accelerator sensor 32 detects an operation amount of an accelerator pedal (not shown) by a driver. The brake sensor 33 detects an operation amount of a brake pedal (not shown) by the driver. The steering angle sensor 34 detects a rotation angle, that is, a steering angle of a steering wheel or a steering shaft (not shown) of the vehicle VH1. The yaw rate sensor 35 detects a yaw rate of the vehicle VH1. The internal sensor device 30 transmits, at a predetermined cycle, a state of the vehicle VH1 detected by each of the sensors 31 to 35 to the ECU 10.

The external sensor device 40 is sensors which acquire object information on objects around the vehicle VH1. Specifically, the periphery recognition device 40 includes a radar sensor 41, a camera sensor 42, and the like. As the object information, there are given, for example, a peripheral vehicle, a white line of a road, and a road sign, and the like.

The radar sensor 41 detects a target object present in the periphery of the vehicle VH1. The radar sensor 41 includes a millimeter wave radar and/or a LiDAR sensor. The millimeter wave radar emits radio waves (millimeter waves) in the millimeter wave band and receives millimeter waves (reflected waves) reflected by a target object present within the radiation range. The millimeter wave radar acquires, for example, a relative distance between the vehicle VH1 and the target object and a relative speed between the vehicle VH1 and the target object based on, for example, a phase difference between the transmitted millimeter waves and the r reflected waves, an attenuation level of the reflected waves, and the time from transmitting the millimeter waves to receiving the reflected waves. The LiDAR sensor sequentially scans pulsed laser light having a wavelength shorter than that of millimeter waves in a plurality of directions, and receives the reflected light reflected by a target object, and based on that, acquires, for example, a shape of a target object detected in front of the vehicle VH1, the relative distance between the vehicle VH and the target object, and a relative speed between the vehicle VH1 and the target object.

The camera sensor 42 acquires target object information on the periphery of the vehicle VH1 by capturing the periphery of the vehicle VH1 and processing image data obtained by capturing the periphery. For example, a digital camera including an image pickup element such as a CMOS device or a CCD can be used as the camera sensor 42. The target object information is information representing the type of the target object detected in the periphery of the vehicle VH1, the relative distance between the vehicle VH1 and the target object, the relative speed between the vehicle VH1 and the target object, and the like. The type of the target object may be recognized by, for example, machine learning such as pattern matching.

The external sensor device 40 repeatedly transmit the acquired object information to the ECU 10 each time a predetermined time elapses. It is not always required for the external sensor device 40 to include both of the radar sensor 41 and the camera sensor 42, and may include, for example, only the radar sensor 41 or only the camera sensor 42.

The direction indicator lever 51 is an operating device which the driver uses to cause the left and right direction indicators (not shown) to blink. The direction indicator switch 50 detects the direction in which the direction indicator lever 51 is operated by the driver. When the driver operates the direction indicator lever 51, the direction indicator switch 50 transmits a blinking instruction signal corresponding to the direction of the operation to the ECU 10. When the ECU 10 receives the blinking instruction signal, the ECU 10 causes the direction indicator corresponding to the direction of the operation of the direction indicator lever 51 to blink.

The position information acquisition device 60 acquires information on the current position of the vehicle VH1. As the position information acquisition device 60, for example, a global positioning system (GPS) or a global navigation satellite system (GNSS), for example, included in a navigation system (not shown) can be used. The position information acquisition device 60 transmits the acquired information on the current position of the vehicle VH1 to the ECU 10 at a predetermined cycle. In addition, the position information on the vehicle VH1 may be acquired by vehicle-to-everything (V2X) communication using the communication device 80, which is described later.

The map database 70 is a database of map information, and is stored in a storage device (for example, hard disk drive or flash memory) included in the vehicle VH1. The map information includes the positions of road intersections and the like. The map database 70 may be stored in an external server capable of communication to and from the vehicle VH1. In this case, the vehicle VH1 may use the communication device 80 to acquire the map information from the external server.

The communication device 80 performs V2X communication. Specifically, the communication device 80 performs vehicle-to-vehicle (V2V) communication to and from the own vehicle VH1 and other vehicles and vehicle-to-infrastructure (V2I) communication to and from the own vehicle VH1 and infrastructure. The communication device 80 can acquire information on the periphery of the own vehicle VH1 through the V2X communication. The information on the periphery includes, for example, the position of an intersection, route information such as straight travel or right or left turn of another vehicle, and the like. The communication device 80 transmits the acquired information on the periphery to the ECU 10 at a predetermined cycle.

The HMI 90 is an interface for inputting and outputting data between the ECU 10 and the drivers, and includes an input device and an output device. Examples of the input device include a touch panel, a switch, and a sound pickup microphone. Examples of the output device include a display device 91 and a speaker 92. The display device 91 is, for example, a center display installed in an instrument panel or the like, a multi-information display, a head-up display, a display of a navigation system, or the like. The speaker 92 is, for example, a speaker of an acoustic system or a navigation system.

### <Software Configuration>

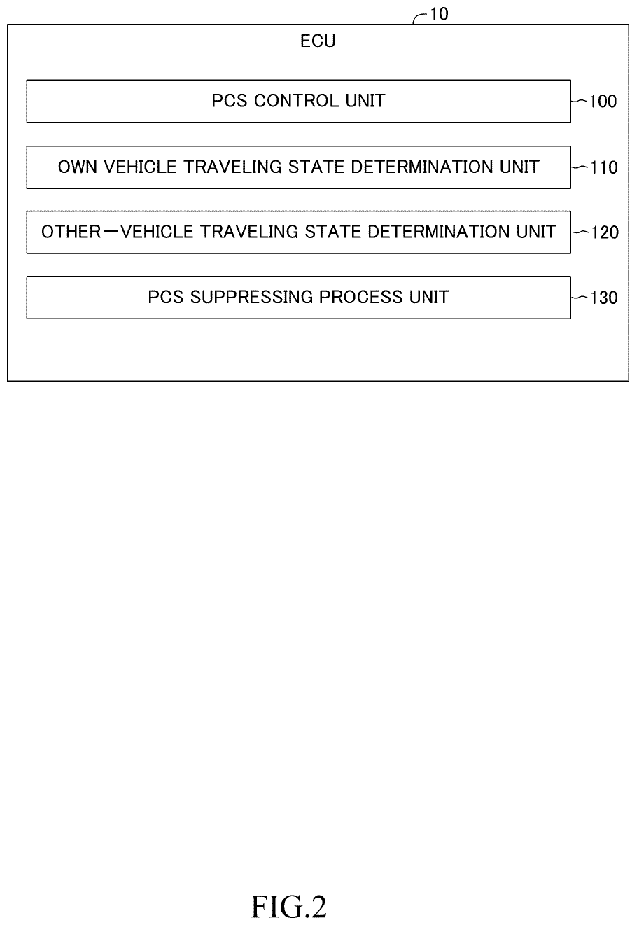

FIG. 2 is a schematic diagram showing a software configuration of the ECU 10 to the present embodiment.

As shown in FIG. 2, the ECU 10 includes a PCS control unit 100, an own vehicle traveling state determination unit 110, an other-vehicle traveling state determination unit 120, a PCS suppressing process unit 130, and the like as functional elements. Those functional elements 100 to 130 are described as being included in the ECU 10 which is integrated hardware, but any part thereof may be provided to an ECU independent of the ECU 10. Moreover, a part of the functional elements 100 to 130 of the ECU 10 may be provided to an external information processing device of a facility (for example, a managing center) which can communicate to and from the vehicle VH1.

The PCS control unit 100 executes the PCS control to avoid collisions or reduce the damage of collisions between the own vehicle VH1 and a forward objects (objects to be controlled) that exist within a predetermined angle range in front of the direction of travel of the own vehicle VH1. The PCS control unit 100 acquires the coordinate information of the object existing in the front direction of the own vehicle VH1 based on the detection result of the external sensor device 40. Further, the PCS control unit 100 calculates the turning radius of the own vehicle VH1 based on the detection results of the vehicle speed sensor 31, the steering angle sensor 34, and the yaw rate sensor 35, and calculates the trajectory of the vehicle VH based on the turning radius. The PCS control unit 100 determines whether a moving object and a stationary object in front of the own vehicle VH1 is obstacle that may collide with the vehicle VH1. When the target object is the moving object, the PCS control unit 100 determines the moving object as an obstacle, when the trajectory of the moving object and the trajectory of the own vehicle VH1 intersect each other. When the target object is the stationary object, the PCS control unit 100 determines that the stationary object is an obstacle when the trajectory of the own vehicle VH1 intersects the present position of the stationary object.

When the PCS control unit 100 determines that the target object is the obstacle, the PCS control unit 100 calculates a predicted collision time (Time To Collision: TTC) until the own vehicle VH1 collides with the obstacle based on the distance L from the own vehicle VH1 to the obstacle and the relative velocity Vr of the own vehicle VH1 with respect to the obstacle. TTC is an index indicating a possibility that the own vehicle VH1 collides with the obstacle. TTC can be determined by dividing the distance L from the own vehicle VH1 to the obstacle by the relative velocity Vr (TTC=L/Vr). The PCS control unit 100 determines that the own vehicle VH1 is highly likely to collide with the obstacle when the state in which TTC is equal to or smaller than the predetermined collision determination threshold TTCv. When determining that there is a high possibility of collision, the PCS control unit 100 executes an alarm by the speaker 92 or the display device 91, and also executes an automated braking control. The automated braking control is a control for reducing the own vehicle VH1 so that the deceleration of the own vehicle VH1 coincides with a predetermined target deceleration by controlling the activation of the braking device 22 and/or the driving device 20. Accordingly, the own vehicle VH1 can be forcibly decelerated without requiring the driver to operate the brake pedal.

The own vehicle traveling state determination unit 110 determines the traveling state (behavior) of own vehicle VH1 in the roundabout and in the vicinity of the roundabout. Herein, the roundabout (traffic circle) refers to an intersection in which a plurality of paths are connected to the circulation path. Specifically, the own vehicle travel state determination unit 110 determines whether the own vehicle VH1 is traveling on the circulation path of the roundabout, whether the own vehicle VH1 is attempting to exit the circulation path of the roundabout, or whether the own vehicle VH1 is attempting to enter the circulation path of the roundabout. The traveling state of the own vehicle VH1 may be determined based on the present position of the own vehicle VH1 acquired by the position information acquisition device 60 and the map database 70, or may be determined based on information acquired by the communication device 80 through V2I communication, or may be determined based on sign information of the roundabout acquired by the external sensor device 40, or the like. Whether the own vehicle VH1 exits the circulation path of the roundabout or enters the circulation path of the roundabout may be determined based on a route set by the navigation system, or may be determined based on a detected result of the direction indicator switch 50, the steering angle sensor 34, or the like.

The other-vehicle traveling state determination unit 120 determines the traveling state (behavior) of the other vehicle VH2in the roundabout detected in the predetermined angular range ahead of the own vehicle VH1 in the traveling direction and in the vicinity of the roundabout. Specifically, the other-vehicle traveling state determination unit 120 determines, as the traveling state of the other vehicle VH2, whether the other vehicle VH2 is traveling on the circulation path of the roundabout, whether the other vehicle VH2 is going to exit the circulation path of the roundabout, or whether the other vehicle VH2 is going to enter the circulation path of the roundabout. The traveling state of the other vehicle VH2 may be determined based on the detection result of the external sensor device 40, or may be determined based on the information of the other vehicle VH2 acquired by the communication device 80 through V2V communication. The other-vehicle travel determination unit 120 transmits the determination result to the PCS suppressing process unit 130.

Incidentally, at the roundabout, even when the own vehicle VH1 is close to the other vehicles VH2 in front of the traveling direction, there are cases where they do not actually intersect. When the risk of such a collision is assumed to be low, there is the issue of the driver of the vehicle VH1 being bothered by the warning given by the PCS control. Further, since there is no need to stop in circulation path of the roundabout, if the automatic braking control is performed by the PCS control despite the low collision risk, there is a possibility that secondary damage caused by the collision with the following vehicles may be caused.

The PCS suppressing process unit 130 executes a suppressing process for suppressing an unnecessary alarm of the PCS control and an activate of the automated braking control based on the determination result by the own vehicle traveling state determination unit 110 and the other-vehicle traveling state determination unit 120, by determining whether or not there is a low-risk collision between the own vehicle VH1 and the other vehicle VH2. In the present embodiment, the process of suppressing the activation of the PCS control includes a process of making the PCS execution condition difficult to be satisfied by increasing the collision determination threshold TTCv, a process of delaying the timing of the activation of the PCS control even if the PCS execution condition is satisfied, and the like. Hereinafter, the PCS control suppressing process by the PCS suppressing process unit 130 will be described in detail.

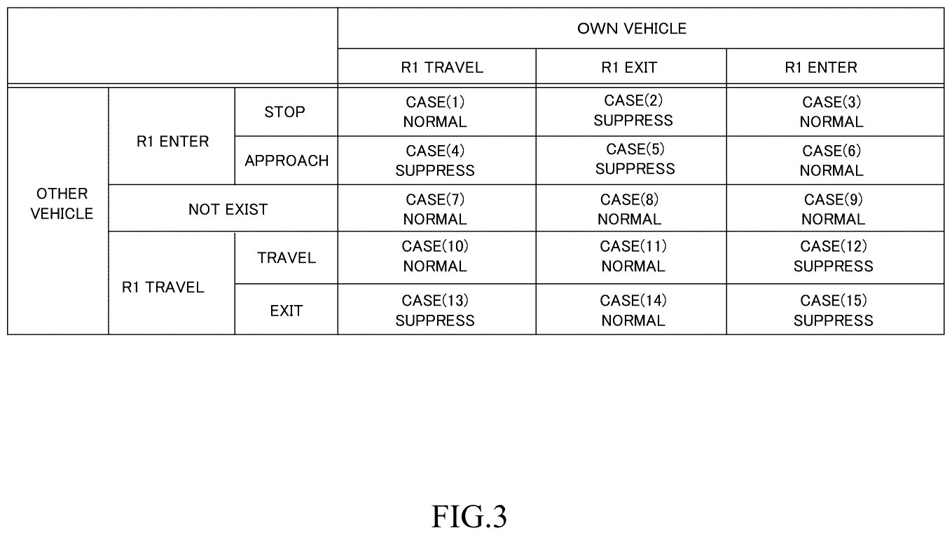

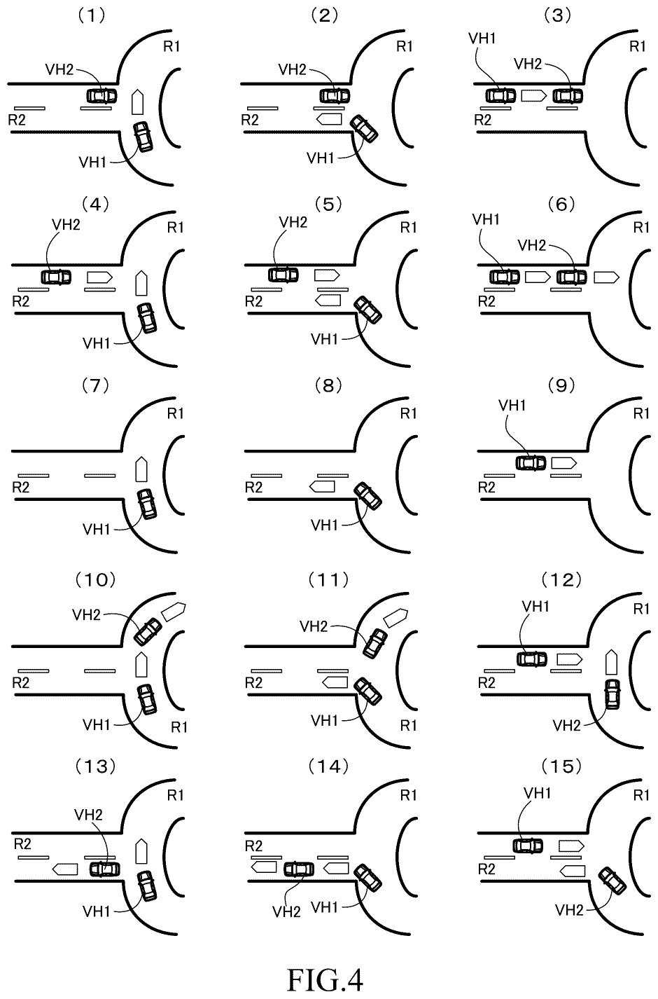

FIG. 3 is a diagram illustrating for explaining a combination of a case where a suppression condition for executing the suppression process of the PCS control and a case where a normal condition for not executing the suppression process is set based on a traveling state of the own vehicle VH1 and the other vehicle VH2 in front of the own vehicle VH1. FIG. 4 is a schematic diagram illustrating each case of FIG. 3. In the following explanation, a path connected to the circulation path R1 of the roundabout is referred to as a connecting path R2.

A case (1) is a scene in which the own vehicle VH1 is traveling along the circulation path R1, and the other vehicle VH2 is stopped (waiting) in front of the circulation path R1 on the connecting path R2. In such a scene, if the other vehicle VH2 enters the circulation path R1, there is a possibility that the own vehicle VH1 and the other vehicle VH2 collide with each other. That is, the collision risk is not low. In such case, the PCS suppressing process unit 130 does not execute the suppressing process. That is, the execution condition of the PCS control is set as the normal condition.

A case (2) is a scene in which, when the own vehicle VH1 exits from the circulation path R1 to the connecting path R2, the other vehicle VH2 is stopped in front of the circulation path R1 of the connecting path R2. The case (2) is a second own vehicle behavior and a fourth other vehicle behavior of the present disclosure. In such a scene, the own vehicle VH1 and the other vehicle VH2 are close to each other, but they do not intersect each other because the own vehicle VH1 exits the connecting path R2. That is, the collision risk is low. In such case, the PCS suppressing process unit 130 executes the suppressing process. That is, the execution condition of the PCS control is set as the suppression condition.

A case (3) is a scene in which, the own vehicle VH1 enter into the circulation path R1 from the connecting path R2, the other vehicle VH2 in front of the own vehicle VH1 stopping on the connecting path R2 in front of the circulation path R1. In such scene, if the braking of the own vehicle VH1 is delayed or the like, there is a possibility that the own vehicle VH1 collides with the other vehicle VH2. That is, the collision risk is not low. In such case, the PCS suppressing process unit 130 does not execute the suppressing process. That is, the execution condition of the PCS control is set as the normal condition.

A case (4) is a scene in which, the own vehicle VH1 is traveling on the circulation path R1 and the other vehicle VH2 approaches to the circulation path R1 from the connecting path R2. The case (4) is a first own vehicle behavior and the first other vehicle behavior of the present disclosure. In such scene, the own vehicle VH1 and the other vehicle VH2 are close to each other, but the own vehicle VH1 passes ahead of the other vehicle VH2 first, so they do not conflict with each other. That is, the collision risk is low. In such case, the PCS suppressing process unit 130 executes the suppressing process. That is, the execution condition of the PCS control is set as the suppression condition.

A case (5) is a scene in which, when the own vehicle VH1 attempts to exit from the circulation path R1 to the connecting path R2, the other vehicle VH2 approaches to the circulation path R1 from the connecting path R2. The case (5) is the second vehicle behavior and the third other vehicle behavior of the present disclosure. In such a scene, the own vehicle VH1 and the other vehicle VH2 are close to each other, but they do not intersect each other because the own vehicle VH1 exits to the connecting path R2. That is, the collision risk is low. In such case, the PCS suppressing process unit 130 executes the suppressing process. That is, the execution condition of the PCS control is set as the suppression condition.

A case (6) is a scene in which, when the own vehicle VH1 attempts to enter the circulation path R1 from the connecting path R2, the other vehicle VH2 in front of the own vehicle VH1 approaches to the circulation path R1 from the connecting path R2. In such a situation, there is a possibility that the own vehicle VH1 and the other vehicle VH2 collide with each other when the braking of the own vehicle VH1 is delayed or the other vehicle VH2 is suddenly braked. That is, the collision risk is not low. In such case, the PCS suppressing process unit 130 does not execute the suppressing process. That is, the execution condition of the PCS control is set as the normal condition.

A case (7) is a scene in which, while the own vehicle VH1 is traveling on the circulation path R1, there is no other vehicle VH2 to enter the circulation path R1 from the connecting path R2 and no other vehicle VH2 traveling on the circulation path R1. A case (8) is a scene in which, when the own vehicle VH1 attempts to exit from the circulation path R1 to the connection path R2, there is no other vehicle VH2 traveling on the circulation path R1 and the other vehicle VH2 attempting to enter the circulation path R1 from the connecting path R2. A case (9) is a scene in which, when the own vehicle VH1 attempts to enter the circulation path R1 from the connecting path R2, there is no other vehicle VH2 that attempts to enter the circulation path R1 from the connecting path R2 and no other vehicle VH2 that is traveling on the circulation path R1. In such case, the PCS suppressing process unit 130 does not execute the suppressing process. That is, the execution condition of the PCS control is set as the normal condition.

A case (10) is a scene in which, when the own vehicle VH1 is traveling on the circulation path R1, the other vehicles VH2 in front of the own vehicle VH1 is also traveling on the circulation path R1. In such a situation, if the other vehicle VH2 is suddenly braked, there is a possibility that the own vehicle VH1 and the other vehicle VH2 collide with each other. That is, the collision risk is not low. In such case, the PCS suppressing process unit 130 does not execute the suppressing process. That is, the execution condition of the PCS control is set as the normal condition.

A case (11) is a scene in which, when the own vehicle VH1 attempts to exit from the circulation path R1 to the connecting path R2, the other vehicle VH2 in front of the own vehicle VH1 is traveling on the circulation path R1. In such a situation, if the other vehicle VH2 is suddenly braked, there is a possibility that the own vehicle VH1 and the other vehicle VH2 collide with each other. That is, the collision risk is not low. In such case, the PCS suppressing process unit 130 does not execute the suppressing process. That is, the execution condition of the PCS control is set as the normal condition.

A case (12) is a scene in which, when the own vehicle VH1 attempts to enter the circulation path R1 from the connection path R2, the other vehicle VH2 traveling the circulation path R1 toward the connection part of the circulation path R1 and the connecting path R2. A case (12) is the third own vehicle behavior and the fifth other vehicle behavior of the present disclosure. In such a situation, the own vehicle VH1 and the other vehicle VH2 are close to each other, but the other vehicle VH2 passes through the connecting part first, so that they do not intersect with each other. That is, the collision risk is low. In such case, the PCS suppressing process unit 130 executes the suppressing process. That is, the execution condition of the PCS control is set as the suppression condition.

A case (13) is a scene in which, when the own vehicle VH1 is traveling on the circulation path R1, the other vehicle VH2 in front of the own vehicle VH1 exits from circulation road R1 to the connecting road R2. A case (13) is the first own vehicle behavior and the second other vehicle behavior of the present disclosure. In such a scene, the own vehicle VH1 and the other vehicle VH2 are close to each other, but the other vehicle VH2 exits from the circulation path R1, so that they do not intersect each other. That is, the collision risk is low. In such case, the PCS suppressing process unit 130 executes the suppressing process. That is, the execution condition of the PCS control is set as the suppression condition.

A case (14) is a scene in which, when the own vehicle VH1 attempts to exit from the circulation path R1 to the connecting path R2, the other vehicle VH2 in front of the own vehicle VH1 also exits from the circulation path R1 to the connecting path R2. In such a situation, if the other vehicle VH2 is suddenly braked there is a possibility that the own vehicle VH1 and the other vehicle VH2 collide with each other. That is, the collision risk is not low. In such case, the PCS suppressing process unit 130 does not execute the suppressing process. That is, the execution condition of the PCS control is set as the normal condition.

A case (15) is a scene in which, when the own vehicle VH1 attempts to enter the circulation path R1 from the connecting path R2, the other vehicle VH2 exits from the circulation path R1 to the connecting path R2. The case (15) is the third own vehicle behavior and the sixth other vehicle behavior of the present disclosure. In such a scene, the own vehicle VH1 and the other vehicle VH2 are close to each other, but the other vehicle VH2 exits to the connecting path R2, so that they do not intersect each other. That is, the collision risk is low. In such case, the PCS suppressing process unit 130 executes the suppressing process. That is, the execution condition of the PCS control is set as the suppression condition.

In the present embodiment, it is determined whether or not the collision risk is low based on the traveling state of the own vehicle VH1 and the traveling state of the other vehicle VH2 in the circulation path R1 and the connecting path R2 as described above, and when the collision risk is low, a suppressing process for suppressing the activation of the PCS control is executed. Accordingly, it is possible to effectively suppress unnecessary activation of the PCS control and the auto braking control. Thus, it can effectively prevent unnecessary alarms from causing drivers discomfort and unnecessary auto braking from causing secondary damage due to the rear collision.

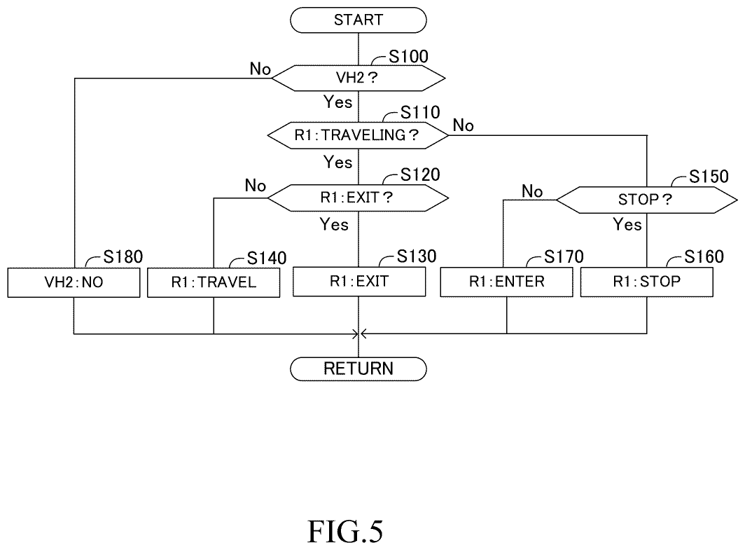

FIG. 5 is a flow chart for explaining a routine of a process of determining the traveling state of the other vehicle VH2 executed by the CPU 11 of the ECU 10.

In step S100, the ECU 10 determines whether or not the other vehicle VH2 (preceding vehicle) exists in front of the own vehicle VH1 based on the detection result of the external sensor device 40 or the like. If the other vehicle VH2 is exists (Yes), the ECU 10 advances the process to step S110. On the other hand, if the other vehicle VH2 does not exist (No), the ECU 10 advances the process to step S180 to determine that there is no other vehicle VH2 to be a preceding vehicle, and returns this routine.

In step S110, the ECU 10 determines whether or not the other vehicle VH2 is traveling on the circulation path R1 based on the detection result of the external sensor device 40 or the information acquired through V2V communication. If the other vehicle VH2 is traveling on the circulation path R1 (Yes), the ECU 10 advances the process to step S120. On the other hand, if the other vehicle VH2 is not traveling on the circulation path R1 (No), the ECU 10 advances the process to step S150.

In step S120, the ECU 10 determines whether or not the other vehicle VH2 exits from the circulation path R1 to the connecting path R2 based on the detection result of the external sensor device 40 or the information acquired through V2V communication. If the other vehicle VH2 exits from the circulation path R1 to the connecting path R2 (Yes), the ECU 10 determines that the other vehicle VH2 exits to the connecting path R2 in step S130, and returns this routine. On the other hand, if the other vehicle VH2 does not exit from the circulation path R1 to the connecting path R2 (No), the ECU 10 determines that the other vehicle VH2 is traveling on the circulation path R1 in step S140, and returns this routine.

In step S150, the ECU 10 determines whether or not the other vehicle VH2 is stopping based on information acquired through the detection result of the external sensor device 40 or V2V communication. If the other vehicle VH2 is stopping (Yes), the ECU 10 advances the process to step S160 and determines that the other vehicle VH2 is stopping (standby) in front of the circulation path R1 of the connecting path R2, and returns this routine. On the other hand, if the other vehicle VH2 is not stopping (No), the ECU 10 advances the process to step S170 and determines that the other vehicle VH2 enters the circulation path R1 from the connecting path R2, and returns this routine.

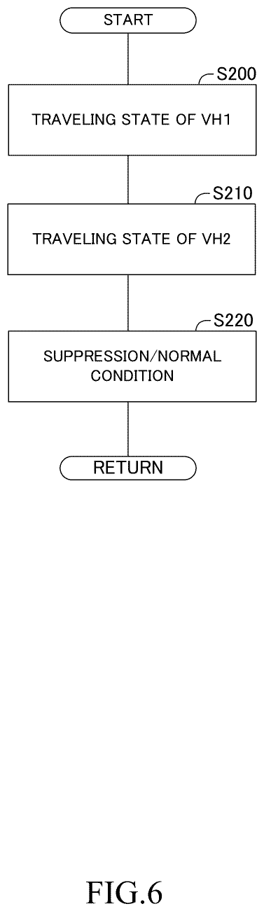

FIG. 6 is a flow chart for explaining a routine of the PCS control suppressing process executed by the CPU 11 of the ECU 10.

In step S200, the ECU 10 determines the traveling state of the own vehicle VH1. Specifically, it is determined whether the own vehicle VH1 is traveling in the circulation path R1, whether the own vehicle VH1 is attempts to exit the circulation path R1, or whether the own vehicle VH1 is attempts to enter the circulation path R1.

Next, in step S210, the ECU 10 determines the traveling state of the other vehicle VH2. The traveling state of the other vehicle VH2 is determined in accordance with the flowchart shown in FIG. 5. Note that the processes of the step S200 and the step S210 are not sequential, and may be performed simultaneously.

Next, in step S220, the ECU 10 determines whether the execution condition of the PCS control is suppression condition or the normal condition that the execution condition of the PCS control is not suppressed based on the determination result of the step S200 and the determination result of the step S210 by referring to the matrices shown in FIG. 4, and returns this routine.

In the above, the vehicle control device according to the at least one embodiment have been described, but the present disclosure is not limited to the above-mentioned at least one embodiment, and various modifications are possible within the range not departing from the object of the present disclosure. For example, in the above embodiment, the PCS control has been described as an exemplary embodiment, but the disclosed technique can be widely applied to other vehicle controls that control the own vehicle VH1 on the basis of the target object to be controlled ahead of the traveling direction. Further, the application of the present disclosure can also be applied to an autonomous vehicle that automatically performs some or all of the driving operations.

What is claimed is:

1. A vehicle control device comprising: a processor,
wherein the processor is configured to execute a vehicle control for assist to reduce a collision risk between an own vehicle and a target object existing in a predetermined angle range in front of a traveling direction of the own vehicle, when an execution condition is satisfied, the execution condition is satisfied when a determination condition that the collision risk is greater than or equal to a predetermined level is satisfied,
wherein the processor is configured to change at least one of the execution condition or the determination condition based on a behavior of the own vehicle on a traveling route and a behavior of other vehicle that is existing on the traveling route, and
wherein the traveling route includes a circulation path of a roundabout and vicinity of the roundabout on a connecting path that connect to the circulation path.

2. The vehicle control device according to claim 1,
wherein the processor is configured to execute, when a first specific condition is satisfied, a suppression process to change at least one of the execution condition or the determination condition more difficult to be satisfied than when the first specific condition is not satisfied,
wherein the first specific condition is satisfied when the behavior of the own vehicle is a first own vehicle behavior and the behavior of other vehicle is either a first other vehicle behavior or a second other vehicle behavior,
wherein the first own vehicle behavior is satisfied when the own vehicle is traveling on the circulation path,
wherein the first other vehicle behavior is satisfied when the other vehicle is traveling on a first connecting path that is connected to the circulation path in front of the traveling direction of the own vehicle, and the other vehicle is approaching to the circulation path for enter the circulation path, and
wherein the second other vehicle behavior is satisfied when the other vehicle is attempting to exit the circulation path and enter the first connecting path.

3. The vehicle control device according to claim 1,
wherein the processor is configured to execute, when a second specific condition is satisfied, a suppression process to change at least one of the execution condition or the determination condition more difficult to be satisfied than when the second specific condition is not satisfied,
wherein the second specific condition is satisfied when the behavior of the own vehicle is a second own vehicle behavior and the behavior of other vehicle is either a third other vehicle behavior or a fourth other vehicle behavior,
wherein the second own vehicle behavior is satisfied when the own vehicle is attempting to exit the circulation path and enter a second connecting path that is connected to the circulation path,
wherein the third other vehicle behavior is satisfied when the other vehicle is travelling on the second connecting path and approaching to the circulation path for enter the circulation path, and
wherein the forth other vehicle behavior is satisfied when the other vehicle is stopping on the second connecting path in front of the circulation path in order to enter the circulation path.

4. The vehicle control device according to claim 1,
wherein the processor is configured to execute, when a third specific condition is satisfied, a suppression process to change at least one of the execution condition or the determination condition more difficult to be satisfied than when the third specific condition is not satisfied,
wherein the third specific condition is satisfied when the behavior of the own vehicle is a third own vehicle behavior and the behavior of other vehicle is either a fifth other vehicle behavior or a sixth other vehicle behavior,
wherein the third own vehicle behavior is satisfied when the own vehicle is travelling on a third connecting path connected to the circulation path in order to enter the circulation path or the own vehicle is stopping on the third connecting path,
wherein the fifth other vehicle behavior is satisfied when the other vehicle is travelling on the circulation path toward a connection part where the circulation path is connected to the third connecting path, and
wherein the sixth other vehicle behavior is satisfied when the other vehicle is attempting to exit the circulation path and enter the third connecting path.
